(19) United States
(12) Patent Application Publication
(10) Pub. No.: US 2018/0272389 A1
(43) Pub. Date: Sep. 27, 2018

(54) Handheld Tool with Interchangeable Tool Heads

(71) Applicant: JOHN CHARLES SHELDON, Oakville (CA)

(72) Inventor: JOHN CHARLES SHELDON, Oakville (CA)

(21) Appl. No.: 15/764,039

(22) PCT Filed: Sep. 27, 2016
(86) PCT No.: PCT/CA2016/051130

§ 371 Date: Mar. 28, 2018

Related U.S. Application Data
(60) Provisional application No. 62/233,763, filed on Sep. 28, 2015.

(51) Int. Cl. B08B 5/02; A46B 5/00; A46B 11/06; B08B 1/00; B08B 3/02

(52) U.S. Cl. CPC B08B 5/02; A46B 5/0095; B08B 3/02; B08B 1/00; A46B 11/06

(57) ABSTRACT

A handheld air compressor accessory tool for cleaning surfaces is disclosed. The handheld air compressor accessory tool can be connected to a source of pressurized air, such as an air compressor or air tank, and a source of cleaning liquid. The air flow of pressurized air and cleaning liquid can be separately controlled by a user when holding the tool in one hand, independent from each other. The handheld tool has interchangeable tool heads, thus enabling a user to quickly change the tool from one use to another.

### FIELD OF INVENTION

The invention relates generally to the field of air compressor tool. In particular, the invention relates to a handheld air compressor accessory tool with interchangeable tool heads for cleaning surfaces.

### INTRODUCTION

To clean a surface may require different tools. For example, it is often desirable to loosen and remove dusts, grime, dirt and other deposits of foreign materials from a surface using a brush. Often, a scraper or an abrasive pad may be desired. Cleaning liquid or detergent also may be applied to such surfaces to help the removal of foreign materials and deposits. It is known to use a mixture of pressurized air and cleaning liquid to wet and loosen the dusts, dirt, among others, and to blow them away or to dry the wet surfaces using pressurized air jet. Often, cleaning liquid is drawn from a reservoir by the suction force of such an air flow supplied by, for example, an air compressor, and applied to the surfaces to be cleaned using a spray gun. However, often, after the application of wet air, it may be necessary to put aside the spray gun and retrieve another tool, such as a brush to loosen the deposit of foreign materials on the surface and brush them away. It may become desirable, after the loosening of the foreign material deposits, to blow away the debris, too. This would require putting away the brush or the scraper, as the case may be, and retrieval of the spray gun. This may become cumbersome when numerous switching back and forth would become required during a single cleaning operation.

Further, different tools may be required for surface cleaning. For example, it may be desirable to use a scraper to loosen sticky or more firmly deposited foreign materials, use a brush to remove debris and dust, and use sponge to remove excess liquid and to dry the surface. It may also require tools of different sizes and shapes. For example, a tool sized for clean a large and generally flat area may not be suitable for cleaning small or narrow areas such as holes and crevices. It may be necessary to stock different tools, such as a set of brushes, crevice tips, scrapers, sponges, abrasive pads, and of different sizes, shapes and dimensions, so that a suitable tool would be available for selection for a particular cleaning task. It may quickly become expensive to stock a large set of tools and also may be inconvenient to transport the whole set to the work site.

It is therefore desirable to have a handheld tool that allows a user to easily switch from one to another, such as from an air and liquid applicator to a cleaning tool. It is also desirable to have a handheld tool that enables its use for different purposes without having to carry a large, bulky or expensive tool set.

The forgoing creates challenges and constraints for providing such a handheld tool. It is an object of the present invention to mitigate or obviate at least one of the above mentioned disadvantages.

### SUMMARY OF INVENTION

The present invention is directed to a handheld air compressor accessory tool with interchangeable tool heads for cleaning surfaces.

In one aspect of the invention, there is provided a handheld tool. The handheld tool has an elongated body having a handle portion and a neck having a tool connector portion formed thereon, the handle portion being shaped and sized for being held in one hand by a user, an interchangeable tool head, the tool head having a engagement portion for engaging the tool connector portion to releasably connect the tool head to the neck, the tool head having a tool implement formed thereon and spaced from the engagement portion, the tool head having a fluid exit; a nebulizing chamber formed on the neck, the nebulizing chamber being in fluid communication with the fluid exit of the tool head, the nebulizing chamber having an air outlet port and a liquid outlet port spaced from the air outlet port, an air passageway having the air outlet port at its first end and an air inlet port at its second end, a liquid passageway having the liquid outlet port at its first end and a liquid inlet port at its second end, an air flow control arrangement having an air actuator for switching on or off pressurized air flow through the air passageway and for adjusting flow rate of the pressurized air flow, and a liquid flow control arrangement having a liquid actuator for switching on or off liquid flow through the liquid passageway and for adjusting flow rate of the liquid flow.

As one feature of this aspect of the invention, the air flow control arrangement includes an air flow valve and the liquid flow control arrangement includes a liquid flow valve. The handheld tool may further include a flow rate limiting device disposed between the liquid flow valve and the liquid outlet port, for setting the flow rate of the liquid flow to a maximum value.

As another feature of the invention, the air passageway includes a throughhole formed inside the elongated body between the air flow control arrangement and the air outlet port. Additionally, the liquid passageway includes an interior section disposed inside the throughhole. As another feature, the liquid passageway includes an interior section formed inside the elongated body and the throughhole has a cross-sectional area larger than that of the interior section of the liquid passageway. As yet another feature, the liquid passageway includes an interior section formed inside the elongated body and the throughhole has an interior body volume larger than that of the interior section of the liquid passageway.

As yet another feature, the air outlet port is positioned forward of the liquid outlet port inside the nebulizing chamber.

The nebulizing chamber may be integrally formed with the neck, or formed from a back wall portion of the neck and a head portion that is formed on a tool head or a chamber cap separate from the neck.

As another feature, the head portion is mated with the neck in a snug fit and a connecting arrangement having two parts each one of which is formed on the head portion and the neck respectfully, the connecting arrangement firmly securing the head portion to the neck. According to this feature, one of the two parts of the connecting arrangement is an O-ring and the connecting arrangement seals connection between the head portion and the neck.

As yet another feature, the tool has a third passageway that is in fluid communication with the fluid exit of the head tool. The tool may further include a third flow control arrangement and a third actuator for switching on or off liquid passage through the third passageway and for adjusting flow rate therethrough.

In another aspect of the invention, there is provided a handheld tool. The hand held tool includes an elongated body having a handle portion and a neck having a tool connector portion formed thereon, the handle portion being shaped and sized for being held in one hand by a user, an interchangeable tool head, the tool head having a engagement portion for engaging the tool connector portion to releasably connect the tool head to the neck, the tool head having a tool implement formed thereon and spaced from the engagement portion, the tool head having a fluid exit; an air passageway having the air outlet port at its first end and an air inlet port at its second end, the air outlet port being in fluid communication with the fluid exit; and an air flow control arrangement having an air actuator for switching on or off pressurized air flow through the air passageway and for adjusting flow rate of the pressurized air flow.

The handheld tool may further include a vacuum port formed on the tool head and in fluid communication with the fluid exit hole, or may further have a vacuum passageway that is in fluid communication with the fluid exit hole at one end and has a vacuum port formed at the other end.

As another feature, the air flow control arrangement of the tool may include an air flow valve biased toward a closed condition. Additionally, the handheld tool may further include a liquid passageway in fluid communication with the fluid exit hole of the tool head. The liquid passageway has a liquid inlet port and a liquid flow control arrangement for switching on or off liquid flow through the liquid passageway and for adjusting flow rate of the liquid flow.

As yet another feature, the liquid flow control arrangement includes a liquid flow valve biased toward a closed condition and may further include a flow rate limiting device for setting the flow rate of the liquid flow to a maximum value.

In other aspects the invention provides various combinations and subsets of the aspects described above.

### BRIEF DESCRIPTION OF DRAWINGS

For the purposes of description, but not of limitation, the foregoing and other aspects of the invention are explained in greater detail with reference to the accompanying drawings, in which:

FIG. 1A illustrates in a perspective view of one example of a handheld tool;

FIG. 1B is a cross-sectional view of the handheld tool shown in FIG. 1A;

FIG. 1C illustrate different tool heads attachable to the neck of the handheld tool;

FIG. 2 illustrates in a detailed perspective view an example of a connecting arrangement for securing a tool head to the neck of the handheld tool of FIGS. 1A and 1B;

FIG. 3A illustrates an example of a nebulizing chamber formed on the neck of the handheld tool, together with a tool head;

FIG. 3B illustrates in a perspective view an example of an air hole formed in a nozzle projected forward of the liquid hole;

FIG. 3C illustrates an example of a nebulizing chamber integrally formed on the neck of the handheld tool;

FIG. 3D illustrates an example of forming a nebulizing chamber with a chamber cap;

FIG. 4A shows in a detailed view a valve and its control lever that may be used to control liquid flow through the liquid passageway in the handheld tool;

FIG. 4B shows in a detailed view a valve and its control lever that may be used to control air flow through the air passageway; and

FIG. 5 shows an alternative tool head that includes a vacuum port.

### DETAILED DESCRIPTION OF EMBODIMENTS

The description which follows and the embodiments described therein are provided by way of illustration of an example, or examples, of particular embodiments of the principles of the present invention. These examples are provided for the purposes of explanation, and not limitation, of those principles and of the invention. In the description which follows, like parts are marked throughout the specification and the drawings with the same respective reference numerals.

A handheld air compressor accessory tool for cleaning surfaces is disclosed. The handheld air compressor accessory tool can be connected to a source of pressurized air, such as an air compressor or air tank, and a source of cleaning liquid. The air flow of pressurized air and cleaning liquid can be separately controlled by a user when holding the tool in one hand, independent from each other. The handheld tool has interchangeable tool heads, thus enabling a user to quickly change the tool from one use to another.

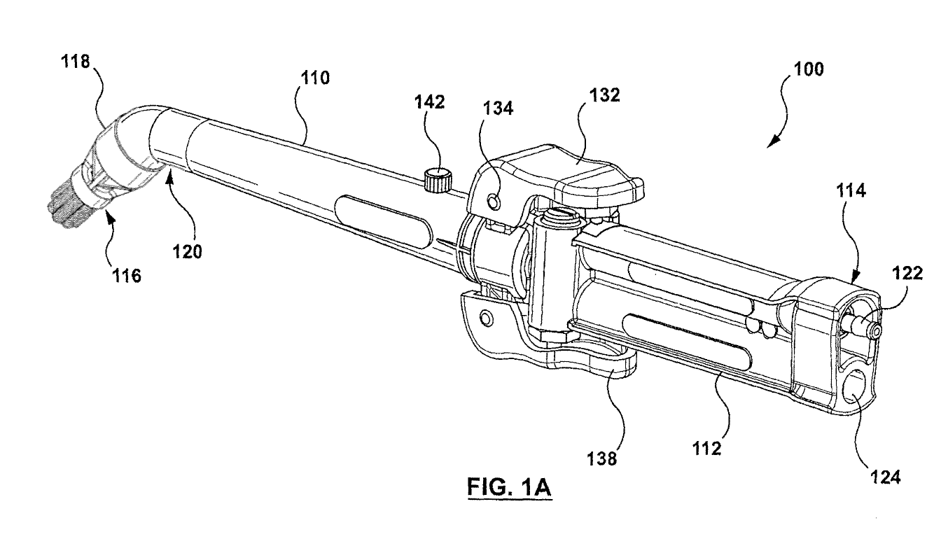

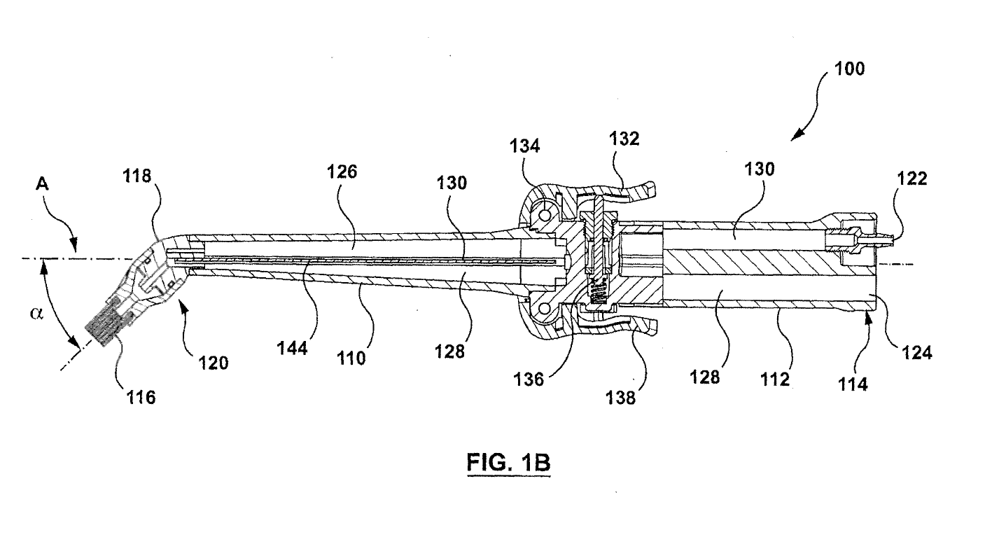

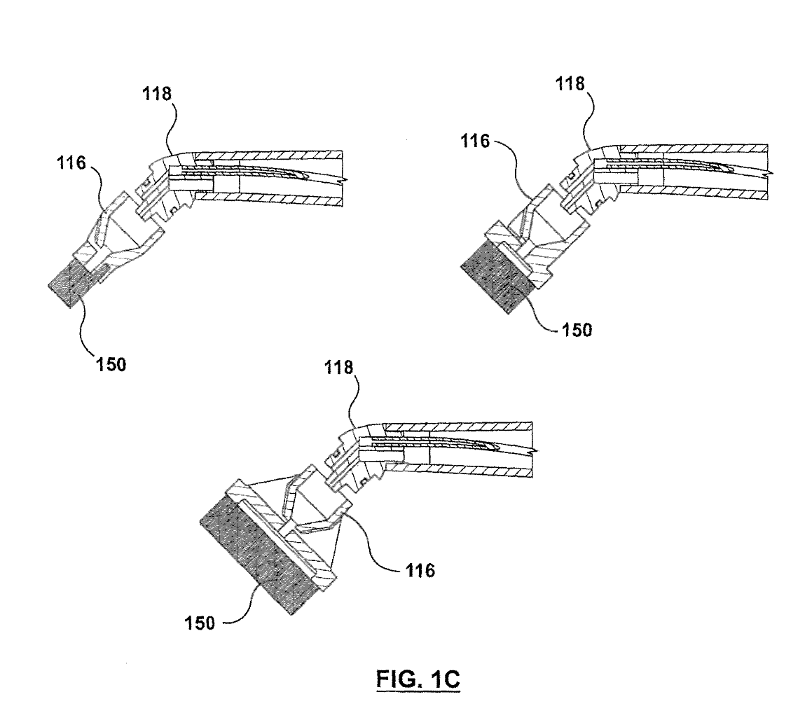

FIG. 1A is a perspective view of one example of a handheld tool 100. FIG. 1B is a cross-sectional view of the handheld tool 100 shown in FIG. 1A. The handheld tool has an elongated body 110, a handle portion 112 at one end 114 of the elongated body 110 and a tool head 116 removably connected to a neck 118 formed at the other end 120. A liquid inlet port 122 is provided at the end 114 for connecting to a source of cleaning liquid, such as a plastic bottle having cleaning liquid stored therein. An air inlet port 124 is also provided at the end 114, for connecting to a source of pressurized air, such an air compressor, by way of an air tube. Throughholes 126 may be formed inside the elongated body 110 to allow air and liquid to pass through. For example, an air passageway 128 is formed inside the elongated body 110, so that pressurized air entering through the air inlet port 124 can pass through the elongated body and exit at the tool head 116. A liquid passageway 130 is also formed inside the elongated body 110, so that liquid drawn from the liquid inlet port can pass through the elongated body 110 and exit at the tool head 116 as a mixture of air and liquid. The handle portion 112 is formed in a shape and size suitable for holding by a user in the hand. Two levers are secured to the handle 112, for a user to control independently flows of pressurized air and clean liquid. For example, an air control lever 132 that is attached to the elongated body and pivots about a pivot point, such as that provided by a pivot pin 134, enables a user to control an air valve 136, to turn on and off the air flow through the air passageway 128 and to control its flow rate at a desired level. Similarly, an liquid control lever 138 is also provided to enable a user to control a liquid valve 140 to control the air flow through the air passageway 128. A knob 142 may be provided to adjust a flow rate limiting device to set a maximum flow rate of the liquid.

Neck 118 is formed on the other end 120 opposite to the end 114. Neck 118 is angled away from center line A of elongated body 110, by an angle α generally in the range 20° to 60°, such as 40°. Neck 118 also may be straight and aligned with center line A. Handheld tool 100 has interchangeable tool head 116 removably connected to neck 118. Tool head 116 has one or more fluid exit holes for the pressurized air, or mixture of pressurized air and clean liquid, to exit the tool head 116 and be applied to the surface to be cleaned. Here, “fluid” may be either air or liquid, or mixture thereof. Different tool heads 116 may be fitted to the neck 118, depending on the task at hand. For example, a tool head may include a brush, a scraper, a sponge or an abrasive pad as a tool implement 150, or may be differently sized, among others. FIG. 1C illustrates an example of brushes of different sizes to be fitted to the neck as tool heads. It will be appreciated by those skilled in the art that although brushes are shown, the tool head, or tool implement, is not limited to brushes. For example, tool heads may include scouring pads, vacuum attachments, inflation kit attachments, paint sprayer attachments such as a portable spray gun or paint brush, squeegee and squeegee with cleaning pad, weed sprayer head, extended blowing tool that extends the tip for tighter hard to reach places, just to name a few.

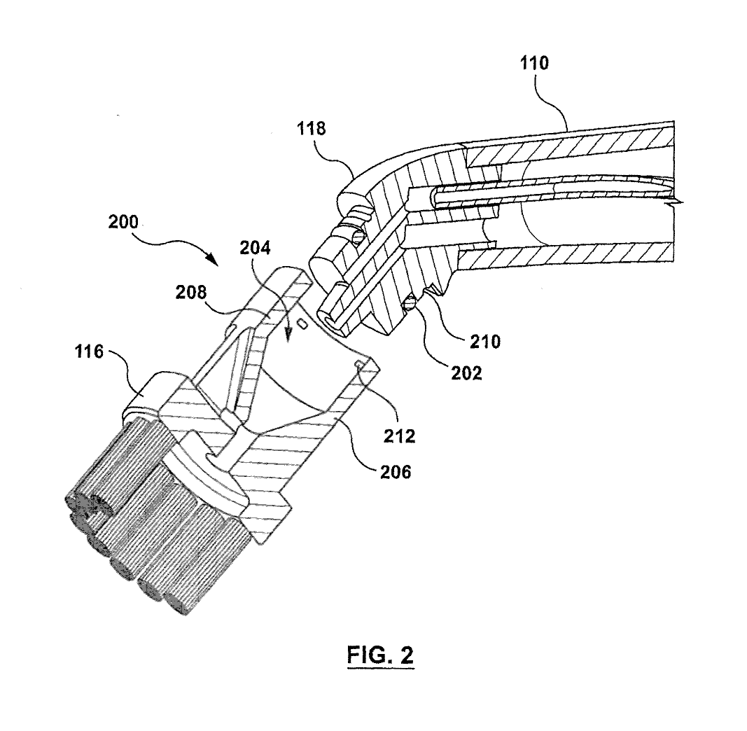

FIG. 2 illustrates in further detail a connecting arrangement 200 that releasably secures tool head 116 to neck 118. Neck 118 and tool head 116 have corresponding portions of cooperating connecting arrangements 200 formed thereon so that a tool head 116 (such as a brush tool head as illustrated in FIG. 1A) can be removably connected to neck 118 and releasably locked to neck 118. For example, the neck 118 may have an O-ring 202 installed on a connector portion as the neck portion of the connecting arrangement 200. The tool head 116 may have a bore 204 having a connection section 206, as a head engagement portion 208 of the connecting arrangement 200. Thus, the tool head 116 is mated with the neck 118 at the connection section 206. The neck 118 and the bore 204 are sized or dimensioned so that the neck 118 fits snuggly in the bore 204. When the tool head 116, namely, the bore 204, is mated with the neck 118, O-ring 202 frictionally and resiliently engages the connection section 206, to lock the tool head 116 to the neck 118. Thus, this snug fit and the resilient property of O-ring also cooperate to provide a locking feature. Alternatively, a groove 210 may be provided as a locking feature 210 of the connecting arrangement 200, for an inwardly extending raised clip or clips 212, inwardly raised edge or inward turning skirt edge, of the bore 204 to snap in and to lock the head tool 116 in place. Of course, it will be appreciated that the locking feature may be provided by any other suitable designs. For example, the connection section 206 may have an internal thread formed thereon to engage with an external thread formed on the neck 118 to firmly secure the tool head 116 to the neck 118. Alternatively, one may simply form a safety hole in both the neck 118 and the tool head 116, with a safety pin inserted therein to lock the tool head 116 to the neck 118. Any other suitable locking features also may be utilized. With the help of the locking feature, a tool head 116 can be removed easily from neck 118, and replaced with a different tool head 116 that may be more suitable for the task at hand, thus changing the handheld tool to a different tool. For example, a brush tool head can be changed to a scraper tool head, changing the handheld tool from a brush to a scraper tool. Each tool head 116 has formed thereon the same head engagement portion 208 of the connecting arrangement 200, to ensure interchangeability.

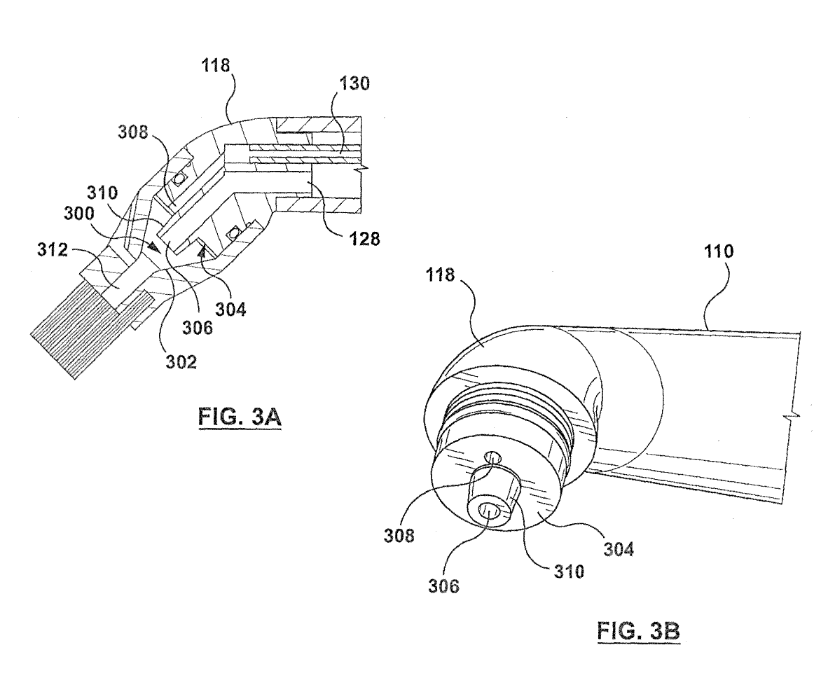

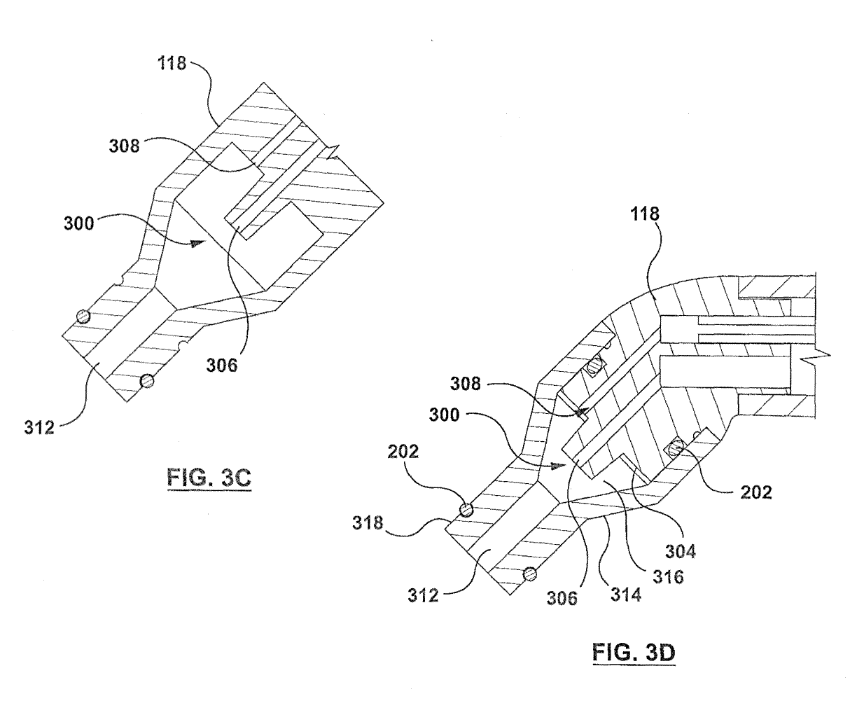

A nebulizing chamber 300, or atomizer, is formed on neck 118. As illustrated in FIG. 3A, the nebulizing chamber 300 has a general bell shape 302 (and in particular, may take the form of a frustum) with the base at the back wall 304. Inside the nebulizing chamber 300, there is an air outlet port, or air hole 306, for introducing pressurized air into nebulizing chamber 300 and a liquid outlet port, or liquid hole 308, for introducing liquid, in particular, cleaning liquid into the nebulizing chamber 300. The bell 302 may have its height generally the same as the diameter of the bell at its base, though the bell may also be more elongated in that the dimension of the height may be larger than the base diameter, such as with a height to base diameter ratio in the range of 1.5 to 2.5, to minimize the back pressure at the liquid hole 308. For better mixing and better atomization, the size of the liquid hole 308 should not be too larger than, and generally should be smaller than, the size of the air hole 306, such as, for example, between ½ to 1/10 of the air hole.

The air hole 306 and the liquid hole 308 are formed on inner wall(s) of the nebulizing chamber 300, for introducing pressurized air and liquid into the nebulizing chamber from outside sources. For example, liquid hole 308 may be formed on a back wall 304 of the nebulizing chamber 300. Air hole 306 may be raised from the back wall 304, for example, formed in a projection, such as on an injector nozzle 310 that is raised and spaced from the back wall 304 (i.e., liquid hole 308). FIG. 3B illustrates in a perspective view of an air hole formed in a nozzle 310 projected forward of the back wall 304, i.e., liquid hole 308. Liquid atomized in nebulizing chamber 300 is mixed with the pressurized air. The mixture is carried forward and out of the nebulizing chamber by the pressurized air through the fluid exit hole 312 of the tool head 116.

For a typical handheld tool 100, the interior of the nebulizing chamber 300 may have a diameter of about 1 cm to 2 cm and a length of comparable dimension. The air hole 306 may have a dimension or diameter of about 3 mm (or between 1 mm and 5 mm) and the liquid hole 308 may have a comparable dimension or smaller, such as about 2 mm (or between 1 mm and 5 mm). Often, a liquid hole that has a dimension or diameter of about ⅓ to ⅔ that of the air hole is found to be suitable. The air hole 306 may be disposed a few millimetres away from the back wall 304, such as at a distance of between 5 mm and 2 cm. In general, the air hole 306 is disposed forward of the liquid hole 308. Here, the direction “forward” is defined by the direction of air flow when the handheld tool 100 is in use, namely a direction away from the back wall 304 and toward the tool head 116. Of course, this forward positioning of air hole 306 is not entirely necessary, especially if the nebulizing chamber 300 is shaped such that any back pressure at the liquid hole 308 created by exiting air from the air hole 306 is minimized.

The concaved bell 302 may be formed on the head portion, namely as part of a tool head 116, as illustrated in FIG. 3A. Aside from forming a nebulizing chamber 300 jointly with a tool head 116 and the neck 118, the nebulizing chamber 300 may be formed in one piece, for example as an internal chamber of a bulging section on neck 118, as illustrated in FIG. 3C. Alternatively, the nebulizing chamber 300 may be formed by attaching a chamber cap 314 to the neck 118 to seal a space therein to form such a chamber as illustrated in FIG. 3D. Referring to FIG. 3D, the chamber cap 314 has a concaved space 316. When the chamber cap 314 is attached to the neck 118, the concaved space 316, together with the back wall 304, forms the nebulizing chamber 300. The neck 118 has one or more O-rings 202. The chamber cap 314 has a corresponding connection which has a snug fit with the neck 118. When the chamber cap 314 is mated with the neck 118, the O-ring or O-rings provides both sealing, so the nebulizing chamber is air tight, and also locking, to prevent the chamber cap 314 being forced off by the pressurised air inside the nebulizing chamber 300 when in use. The chamber cap 314 may have its own connection neck 318 for mating with a tool head 116 and also has fluid exit hole 312 to provide fluid communication between the nebulizing chamber and the tool head 116 fitted thereon. An O-ring 202 or several O-rings may also be provided on the connection neck 318 to seal the connection.

Air and cleaning liquid are mixed in the nebulizing chamber 300. Referring to FIG. 1B and FIG. 3A, air passageway 128 connects air inlet port 124 at one end 114 of the handle 112 to the air outlet port, air hole 306. An air tube, for example, of an air compressor, or any other suitable source of pressurized air, may be connected to the air inlet port 124 to provide the source of pressurized air. In general, the air pressure is maintained in a desired range, such as between 30 psi and 120 psi. Similarly, liquid passageway 130 connects the liquid inlet port 122 with the liquid hole 308. The liquid inlet port 122 at one end 114 of the handle 112 provides an entrance of liquid and may be connected to a source of liquid supply, such as a container of cleaning liquid.

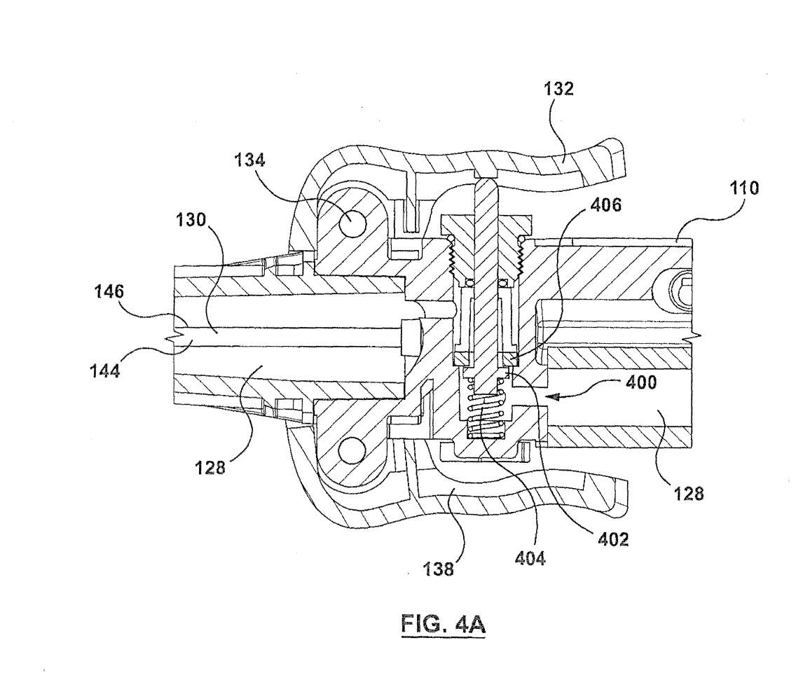

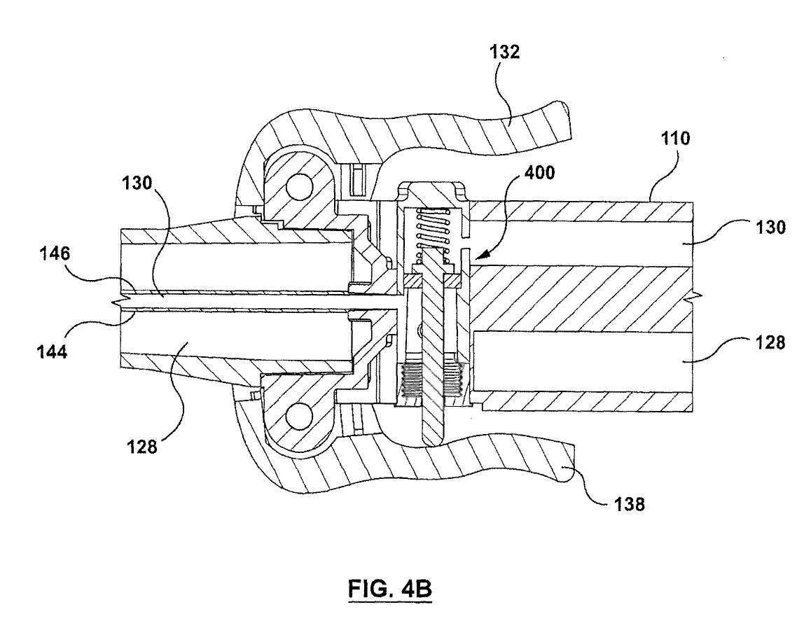

Flows of pressurized air and liquid through their respective passageways can be controlled independently. Valves or any other suitable flow rate control devices may be used. For example, an air valve, such as a spring-biased air valve 136 as shown in FIG. 1B, may be provided to turn on or off the air flow, and to regulate its flow rate. This is shown more clearly in a detailed view in FIG. 4A.

Reference is made to FIG. 4A. An actuator, such as an air control lever 132, is attached to the elongated body 110. The control lever is pivotable about pivot pin 134. A user opens or closes a spring-biased valve 400 by controllably pressing the lever towards the elongated body 110. The spring-biased valve 400 has a valve closure member 402 that is biased by a valve spring 404 against a valve seat 406 of the spring-biased valve 400, to maintain the valve in a closed state. As a user presses down the lever, the valve closure member 402 is forced away from the valve seat 406 against biasing force provided by valve spring 404, thus opens the valve. The further the air control lever 132 is pressed down, the more fully the valve is opened. This enables a user to control the on or off of the flow of pressurized air, and also its flow rate, and ultimately the air flow through the air passageway 128 and at the air outlet port 306. Liquid flow through the liquid passageway may be similarly controlled or regulated by controlling another spring-biased valve 400 as an liquid valve 140 using the liquid control lever 138 as shown in FIG. 4B.

In FIG. 4A and FIG. 4B, examples of mechanically controlled valves are used to explain the control and regulation of flows through the air and liquid passageways. It will be appreciated that they are not the only manner to provide the control function to a user. For example, the actuator may be an electric switch or button if the liquid valve 140 or air valve 136 is electrically controlled or if an electrically controlled flow regulating device is used instead of a mechanical valve. As will be appreciated by one skilled in the art, any flow rate control device may be used and the appropriate actuator will enable a user to control the air or liquid flow.

As illustrated in FIG. 1B, such a flow rate control device divides the passageways into two halves, a first half between the flow rate control device and the respective inlet ports, and a second half between the flow rate control device and the respective outlet ports. The second half of the liquid passageway may be a section that is placed in the interior of the air passageway. FIG. 1B illustrates an example in which the second half 144 of liquid passageway 130 is an interior section, namely a thin tube 146, disposed inside air passageway 128. This particular placement is not required. The liquid passageway may be outside of air passageway. Nevertheless, placing the second half 144 of liquid passageway 130 inside the air passageway 128 provides one advantage. Because of the small size of the thin tube 146, the volume of residue liquid remaining inside the thin tube after shut-off of the liquid valve 140 is reduced and thus the residual liquid can be quickly sucked out and removed by the pressurized air flow. Thus, this helps avoids the need to clean or dry the cleaning liquid after its use. For this purpose, the diameter of the thin tube is selected to be much smaller than the size (or diameter) of the air passageway, for example, at a ratio of about 1:10 to about 1:3, and at least 1:3. More generally, this may also be measured by a ratio of body volume of the interior of the second half of the liquid passageway and that of the second half of the air passageway (which is preferably in a range of 1:1000 to 1:10), or a ratio of cross-sectional area of the interior of the second half of the liquid passageway and that of the second half of the air passageway (which is preferably in a range of 1:100 to 1:10).

Returning to FIG. 1A, a flow rate limiting device adjustable using a knob 142 may be provided at a location between the valve and the nebulizing chamber, such as near or on the neck 118, or near or adjacent the valve control levers. Knob 142 can be used to adjust, i.e., to set a maximum flow rate of the liquid. This can be useful, to prevent liquid from being drawn into the tool (i.e., the liquid passageway) too quickly, thus creating too large a negative pressure at the liquid reservoir, collapsing the container of the liquid. Although a user may manually control the liquid control lever 138 to achieve the same result, i.e., limiting the flow rate of liquid to certain desired level, using a knob to set the maximum flow rate enables a more precise control and also a more consistent flow rate, free from any control inconsistencies caused by a user, for example, due to muscle fatigue.

As will be appreciated, although a liquid passageway and control of liquid flow therethrough have been described in detail, they are not required. A handheld tool may have only an air passage way and its flow control arrangement for controlling air flow therethrough, but still retain the interchangeable tool head. This still enables a user to have the convenience of using the tool implement formed on a tool head to clean the surface and use the pressurized air to blow away the debris or loosened dust or dirt as required. Additionally, whether a handheld tool as described herein include both air and liquid passageways or only the air passageways, such a handheld tool may be further combined with a vacuum function, as described below.

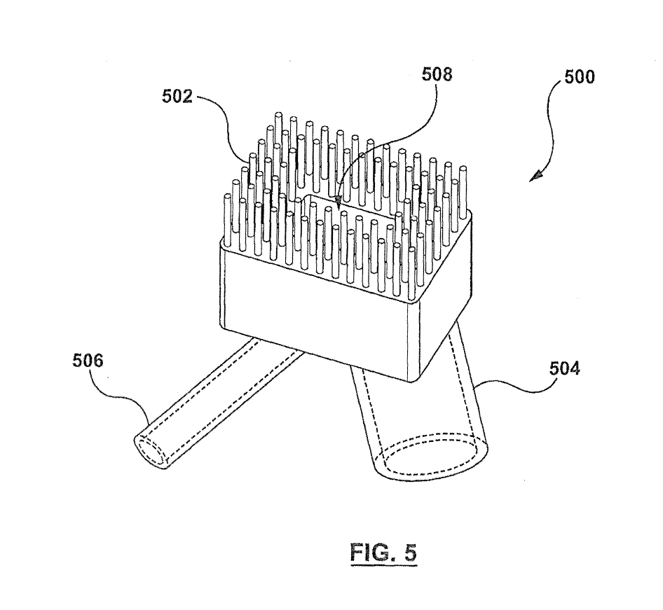

As another feature, the air inlet port 124 can be connected to a vacuum source. This can be useful. The suction force created by the vacuum source can help remove the loose dirt and debris from the surface cleaned or loosened by the application of mixture of pressurized air and cleaning liquid and the loosening by the tool head. As a further alternative, in addition to the air passageways 128 and liquid passageways 130, a third passageway may be formed for connecting to a vacuum source. This third passageway may be similarly controlled by a flow rate control device, such as a valve, which is in turn controllable by user using a third actuator, such as a third lever. This third controlled passageway makes a vacuum source always accessible. Alternatively, this vacuum function may be provided at the tool head. FIG. 5 provides such an example. As shown in FIG. 5, tool head 500 has a similar construction as that of tool head 116, including the tool implement 502, such as a brush, and the connection section 504, which is to be connected with neck 118. Additionally, tool head 500 also includes an additional port 506, for connecting to a source of vacuum, such as a hose of a vacuum machine. The additional port 506 is in fluid communication with the fluid exit hole 508, so that when the additional port is connected to the vacuum source, any debris can be removed through the fluid exit hole 508 by the suction force created by the vacuum source.

Various embodiments of the invention have now been described in detail. Those skilled in the art will appreciate that numerous modifications, adaptations and variations may be made to the embodiments without departing from the scope of the invention, which is defined by the appended claims. The scope of the claims should be given the broadest interpretation consistent with the description as a whole and not to be limited to these embodiments set forth in the examples or detailed description thereof.

1. A handheld tool, comprising:
an elongated body having a handle portion and a neck having a tool connector portion formed thereon, the handle portion being shaped and sized for being held in one hand by a user,
an interchangeable tool head, the tool head having a engagement portion for engaging the tool connector portion to releasably connect the tool head to the neck, the tool head having a tool implement formed thereon and spaced from the engagement portion, the tool head having a fluid exit;
a nebulizing chamber formed on the neck, the nebulizing chamber being in fluid communication with the fluid exit of the tool head, the nebulizing chamber having an air outlet port and a liquid outlet port spaced from the air outlet port,
an air passageway having the air outlet port at its first end and an air inlet port at its second end,
a liquid passageway having the liquid outlet port at its first end and a liquid inlet port at its second end,
an air flow control arrangement having an air actuator for switching on or off pressurized air flow through the air passageway and for adjusting flow rate of the pressurized air flow, and
a liquid flow control arrangement having a liquid actuator for switching on or off liquid flow through the liquid passageway and for adjusting flow rate of the liquid flow.

2. The handheld tool of claim 1, wherein the air flow control arrangement includes an air flow valve and the liquid flow control arrangement includes a liquid flow valve.

3. The handheld tool of claim 2, further comprising a flow rate limiting device disposed between the liquid flow valve and the liquid outlet port, for setting the flow rate of the liquid flow to a maximum value.

4. The handheld tool of claim 2, wherein either the air flow valve or the liquid flow valve is biased toward a closed condition.

5.-8. (canceled)

9. The handheld tool of claim 1, wherein the air passageway includes a throughhole formed inside the elongated body between the air flow control arrangement and the air outlet port.

10. The handheld tool of claim 9, wherein the liquid passageway includes an interior section disposed inside the throughhole.

11. The handheld tool of claim 9, wherein the liquid passageway includes an interior section formed inside the elongated body and the throughhole has a cross-sectional area larger than that of the interior section of the liquid passageway.

12. The handheld tool of claim 9, wherein the liquid passageway includes an interior section formed inside the elongated body and the throughhole has an interior body volume larger than that of the interior section of the liquid passageway.

13. The handheld tool of claim 1, wherein the air outlet port is positioned forward of the liquid outlet port inside the nebulizing chamber.

14. (canceled)

15. The handheld tool of claim 1, wherein the nebulizing chamber is formed from a head portion and a back wall portion of the neck, and the head portion is formed on a tool head or a cap separate from the neck.

16. The handheld tool of claim 15, wherein the head portion is mated with the neck in a snug fit and a connecting arrangement having two parts each one of which is formed on the head portion and the neck respectfully, the connecting arrangement firmly securing the head portion to the neck.

17. (canceled)

18. The handheld tool of claim 1, further comprising a third passageway, the third passageway being in fluid communication with the fluid exit of the head tool.

19. The handheld tool of claim 18, further comprising a third flow control arrangement and a third actuator for switching on or off liquid passage through the third passageway and for adjusting flow rate therethrough.

20. The handheld tool of claim 1, wherein the elongated body defines a center line and the neck is angled away from the center line by a non-zero angle.

21. (canceled)

22. A handheld tool, comprising:
an elongated body having a handle portion and a neck having a tool connector portion formed thereon, the handle portion being shaped and sized for being held in one hand by a user,
an interchangeable tool head, the tool head having a engagement portion for engaging the tool connector portion to releasably connect the tool head to the neck, the tool head having a tool implement formed thereon and spaced from the engagement portion, the tool head having a fluid exit;
an air passageway having the air outlet port at its first end and an air inlet port at its second end, the air outlet port being in fluid communication with the fluid exit; and
an air flow control arrangement having an air actuator for switching on or off pressurized air flow through the air passageway and for adjusting flow rate of the pressurized air flow.

23. The handheld tool of claim 22, further comprising a vacuum port, said vacuum port being formed on the tool head and in fluid communication with the fluid exit hole.

24. (canceled)

25. The handheld tool of claim 22, wherein the air flow control arrangement includes an air flow valve biased toward a closed condition.

26. The handheld tool of claim 25, further comprising a liquid passageway in fluid communication with the fluid exit hole of the tool head, the liquid passageway having a liquid inlet port, and a liquid flow control arrangement having a liquid actuator for switching on or off liquid flow through the liquid passageway and for adjusting flow rate of the liquid flow.

27. The handheld tool of claim 22, wherein the liquid flow control arrangement includes a liquid flow valve biased toward a closed condition.

28. The handheld tool of claim 27, further comprising a flow rate limiting device for setting the flow rate of the liquid flow to a maximum value.
